(19) United States
(12) Patent Application Publication
(10) Pub. No.: US 2014/0191828 A1
(43) Pub. Date: Jul. 10, 2014

(54) ELECTROMAGNETIC WAVE PROPAGATION SHEET AND DISPLAY SHELF IMPLEMENTING ELECTROMAGNETIC WAVE PROPAGATION SHEET

(71) Applicants: Koichiro Nakase, Tokyo (JP); Tsuneo Tsukagoshi, Tokyo (JP)

(72) Inventors: Koichiro Nakase, Tokyo (JP); Tsuneo Tsukagoshi, Tokyo (JP)

(73) Assignee: NEC Corporation, Tokyo (JP)

(21) Appl. No.: 14/233,650

(22) PCT Filed: Jun. 22, 2012
(86) PCT No.: PCT/JP2012/066088

§ 371 Date: Jan. 17, 2014

(30) Foreign Application Priority Data
Jul. 21, 2011 (JP) 2011-159565

(51) Int. Cl. H01P 3/00

(52) U.S. Cl. CPC H01P 3/00
USPC 333/239

(57) ABSTRACT

Provided is an electromagnetic wave propagation sheet constituted by a mesh-shaped conductor layer, a planar conductor layer, and an inductor layer sandwiched therebetween, wherein the mesh-shaped conductor layer and the planar conductor layer are electrically connected to each other in an end section of the electromagnetic wave propagation sheet by a short conductor, and a mesh-shaped conductor that constitutes the mesh-shaped conductor layer has a meander shape in the vicinity of the electromagnetic wave propagation sheet end section.

### TECHNICAL FIELD

The present invention relates to an electromagnetic wave propagation sheet, and more particularly, to an electromagnetic wave propagation sheet, a width of which is reduced, and a display shelf implementing the electromagnetic wave propagation sheet.

### BACKGROUND ART

In addition to one-dimensional communication by a wire and three-dimensional communication by an electric wave, two-dimensional communication is proposed as a new communication type and partially used. A basic configuration of the two-dimensional communication system is constituted by an electromagnetic wave propagation sheet and a proximity coupler. The proximity coupler is an electromagnetic coupling element used to exchange electromagnetic waves between an electromagnetic wave propagation sheet and an external instrument. In the two-dimensional communication, since input and output of the electromagnetic wave are performed at an arbitrary place on the sheet, a clear cableless operation environment can be realized in comparison with the wired communication.

In addition, the two-dimensional communication has an advantage of electric power saving, in which loss due to diffusion is reduced, to confine the electromagnetic wave in the sheet, in comparison with the communication by the electric wave. In the electromagnetic wave propagation sheet, for example, as disclosed in Patent Document 1 or Non Patent Document 1, a dielectric layer is configured to be sandwiched between two conductor layers, one of the conductor layers is planar, and the other one of the conductor lavers has a mesh shape. The electromagnetic wave propagated in the sheet is leaked from an opening section of a mesh-shaped conductor as an evanescent wave. Exchange of the electromagnetic waves between the sheet and the coupler is performed using these.

The two-dimensional communication technique can be applied to power transmission as well as communication. By injecting high frequency power into the electromagnetic wave propagation sheet from the high frequency power source, supply of the power to an electronic instrument can be performed by performing power reception and rectification in the coupler.

### DESCRIPTION OF THE PRIOR ART

### Patent Document

[Patent Document 1] Japanese Unexamined Patent Application, First Publication No. 2007-281678

### Non Patent Document

[Non Patent Document 1]

Non Patent Document 1: Hiroyuki Shinoda, et al., “Simultaneous Transmission Method of Signal and Power using Surface Microwave (Theory Supporting Ubiquitous/Sensor Network, and General),” Electronics Information Communication Institute Corporation, Technical Research Report Vol. 107, No. 53 (20070517) pp.

115-118

### DISCLOSURE OF INVENTION

### Problems to be Solved by the Invention

In the electromagnetic wave propagation sheet of the related art, since occurrence of leakage of the electromagnetic wave from the end section of the electromagnetic wave propagation sheet is suppressed, the mesh-shaped conductor and the planar conductor may be electrically connected to each other in the sheet end section. Hereinafter, a structure in which the two conductors are connected in the sheet end section as described above will be referred to as a short end structure.

FIGS. 9A to 9C show an electromagnetic wave propagation sheet 101 to which the short end structure is applied. The electromagnetic wave propagation sheet 101 is constituted by a three-layered structure including a surface conductor layer 102 formed of a mesh-shaped conductor, a rear surface conductor layer 3 formed of a planar conductor, and a dielectric layer 4 sandwiched between these conductor layers. The mesh-shaped conductor configured to form the surface conductor layer 102 has a shape in which linear conductors are arranged in a lattice shape.

As shown in a side view of FIG. 9B, the mesh-shaped conductor configured to form the surface conductor layer 102 and the planar conductor configured to form the rear surface conductor layer 3 are connected to each other in the end section of the electromagnetic wave propagation sheet 101 by a short conductor 5, and all four surfaces of the sheet end section are surrounded by the short conductor 5.

In addition, while the electromagnetic wave propagation sheet is assumed to be used in a two-dimensional shape such as a mat, a merit obtained by a one-dimensional rail shape is also provided. The rail-shaped electromagnetic wave propagation sheet can improve transmission efficiency without reducing electricity diffusion in a widthwise direction, and can be implemented in a gap of a conventional layout because space can be saved.

When the short end structure is applied to the rail-shaped electromagnetic wave propagation sheet, a cutoff frequency is present like the rectangular waveguide, and thus a low frequency electromagnetic wave is not propagated. That is, a sheet width cannot be reduced to be smaller than a specific dimension determined by a frequency of the electromagnetic wave to be propagated, i.e., half of a wavelength of the electromagnetic wave in the sheet transmission path. In the rail-shaped electromagnetic wave propagation sheet elongated in one direction, when the sheet width can be reduced to be smaller than the limited dimension and the electromagnetic wave propagation sheet having a small implementation space can be realized, further expansion of an application field of the two-dimensional communication system can be expected.

In consideration of the above-mentioned circumstances, the present invention is directed to provide a two-dimensional communication system constituted by a mesh-shaped conductor layer, a planar conductor layer, and an inductor layer sandwiched therebetween and capable of expanding an application range thereof by reducing a sheet width of a rail-shaped electromagnetic wave propagation sheet elongated in one direction to provide an electromagnetic wave propagation sheet having a small implementation space.

### Means for Solving the Problem

In order to solve the aforementioned problems, an electromagnetic wave propagation sheet according to the present invention is constituted by a mesh-shaped conductor layer, a planar conductor layer, and an inductor layer sandwiched therebetween, wherein the mesh-shaped conductor layer and the planar conductor layer are electrically connected to each other in an end section of the electromagnetic wave propagation sheet by a short conductor, and a mesh-shaped conductor that constitutes the mesh-shaped conductor layer has a meander shape in the vicinity of the electromagnetic wave propagation sheet end section.

In addition, an electromagnetic wave propagation sheet according to the present invention is constituted by a mesh-shaped conductor layer, a planar conductor layer, and a dielectric layer sandwiched therebetween, wherein the mesh-shaped conductor layer and the planar conductor layer are electrically connected to each other in an end section of the electromagnetic wave propagation sheet by a short conductor, and a mesh-shaped conductor that constitutes the mesh-shaped conductor layer has a spiral shape in the vicinity of the electromagnetic wave propagation sheet end section.

Further, an electromagnetic wave propagation sheet according to the present invention is constituted by a mesh-shaped conductor layer, a planar conductor layer, and a dielectric layer sandwiched therebetween, wherein the mesh-shaped conductor layer and the planar conductor layer are electrically connected to each other in an end section of the electromagnetic wave propagation sheet by a short conductor, and a mesh-shaped conductor that constitutes the mesh-shaped conductor layer has a small line width in the vicinity of the electromagnetic wave propagation sheet end section.

Furthermore, an electromagnetic wave propagation sheet according to the present invention is constituted by a mesh-shaped conductor layer, a planar conductor layer, and a dielectric layer sandwiched therebetween, wherein the mesh-shaped conductor layer and the planar conductor layer are electrically connected to each other in an end section of the electromagnetic wave propagation sheet by a short conductor, and a magnetic body is applied in the vicinity of the electromagnetic wave propagation sheet end section.

### Effects of the Invention

According to the electromagnetic wave propagation sheet of the present invention, in the electromagnetic wave propagation sheet constituted by the mesh-shaped conductor layer, the planar conductor layer, and the inductor layer sandwiched therebetween, since inductance of the ferromagnetic field domain near the sheet end section is increased, a wavelength of the electromagnetic wave of the sheet transmission path can he reduced. Accordingly, in the electromagnetic wave propagation sheet, a sheet width can be reduced to be smaller than a specific dimension determined by a frequency of the electromagnetic wave to be propagated to the sheet.

### BRIEF DESCRIPTION OF THE DRAWINGS

FIG. 1A is a three-orthographic view of an electromagnetic wave propagation sheet according to a first embodiment of the present invention;

FIG. 1B is a cross-sectional view of the electromagnetic wave propagation sheet according to the first embodiment of the present invention taken along line A-A of FIG. 1A;

FIG. 1C is a view of the electromagnetic wave propagation sheet according to the first embodiment of the present invention when seen in a direction of an arrow B of FIG. 1A;

FIG. 2 is a plan view showing a variant of the first embodiment;

FIG. 3A is a three-orthographic view of an electromagnetic wave propagation sheet according to a second embodiment of the present invention;

FIG. 3B is a cross-sectional view of the electromagnetic wave propagation sheet according to the second embodiment of the present invention, taken along line C-C of FIG. 3A;

FIG. 4 is a plan view of an electromagnetic wave propagation sheet according to a fourth embodiment of the present invention;

FIG. 5 is a graph showing simulation of a wavelength reduction effect of the electromagnetic wave propagation sheet according to the fourth embodiment;

FIG. 6 is a side view showing an application example of an electromagnetic wave propagation sheet according to a fifth embodiment of the present invention;

FIG. 7A is a perspective view of a shelf plate to which the electromagnetic wave propagation sheet of the present invention is applied;

FIG. 7B is a side view of the shelf plate to which the electromagnetic wave propagation sheet of the present invention is applied;

FIG. 7C is a perspective view of the display shelf to which the electromagnetic wave propagation sheet of the present invention is applied;

FIG. 8 is a perspective view showing a variant of an application example of the electromagnetic wave propagation sheet according to the fifth embodiment of the present invention;

FIG. 9A is a three-orthographic view showing an electromagnetic wave propagation sheet of the related art;

FIG. 9B is a cross-sectional view of the electromagnetic wave propagation sheet of the related art, taken along line D-D of FIG. 9A;

FIG. 9C is a view of the electromagnetic wave propagation sheet of the related art, when seen in a direction of an arrow E of FIG. 9A;

FIG. 10A is a perspective view of the electromagnetic wave propagation sheet of the related art; and

FIG. 10B is a side view of the electromagnetic wave propagation sheet of the related art.

### EMBODIMENTS FOR CARRYING OUT THE INVENTION

### First Embodiment

Hereinafter, an embodiment of the present invention will be described in detail with reference to the accompanying drawings.

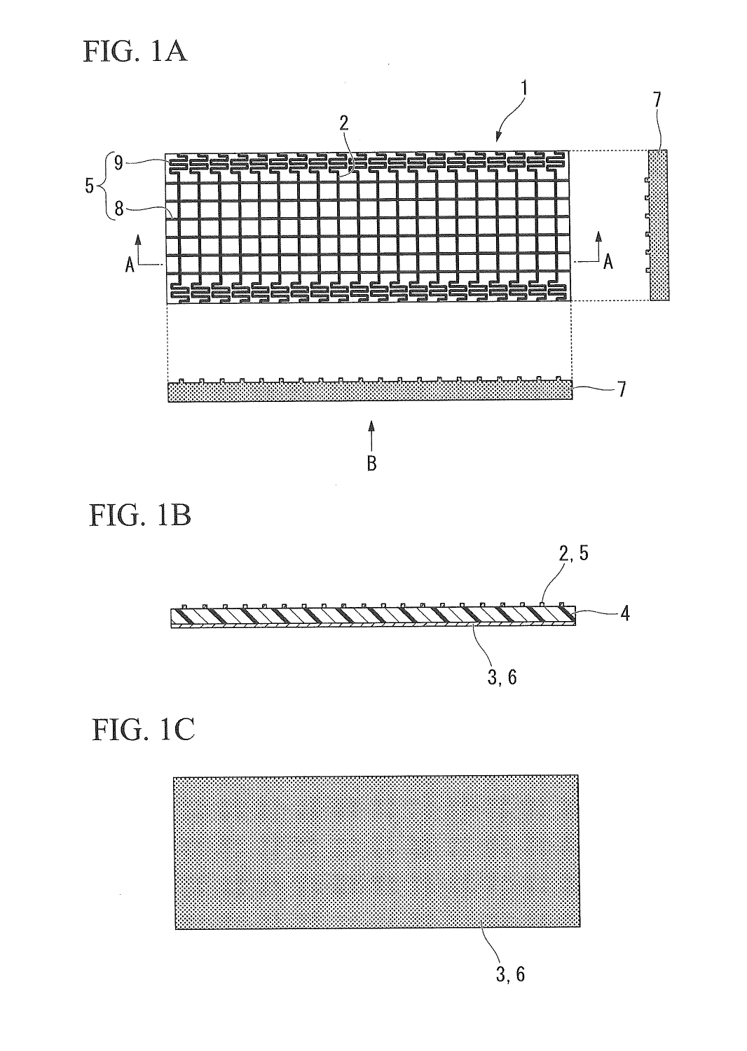

FIGS. 1A to 1C are views showing a first embodiment for performing the present invention. An electromagnetic wave propagation sheet 1 is a plate-shaped sheet having a rectangular shape when seen in a plan view and is constituted by a surface conductor layer 2 formed of a mesh-shaped conductor 5, a rear surface conductor layer 3 formed of a planar conductor 6, and a dielectric layer 4 sandwiched between these conductor layers. The dielectric layer 4 may employ, for example, a foam body formed of a polymer.

As shown in the side view of FIG. 1B, the mesh-shaped conductor 5 configured to form the surface conductor layer 2 and the planar conductor 6 configured to form the rear surface conductor layer 3 are connected to each other in an end section of the electromagnetic wave propagation sheet 1 by a short conductor 7, and all four surfaces of the sheet end section are surrounded by the short conductor 7. The short end structure can be realized by attachment of a conductive tape or application of conductive paint.

While the mesh-shaped conductor 5 has a shape in which linear conductors 8 are arranged in a lattice shape, a meander-shaped conductor 9 having a zigzag meander shape is provided in the vicinity of the sheet end section of the linear conductor 8, and the meander-shaped conductor 9 is connected to the short conductor 7. In addition, the meander shape is a shape in which all or a portion thereof is formed in a zigzag to accommodate an antenna having a certain effective length in a limited space.

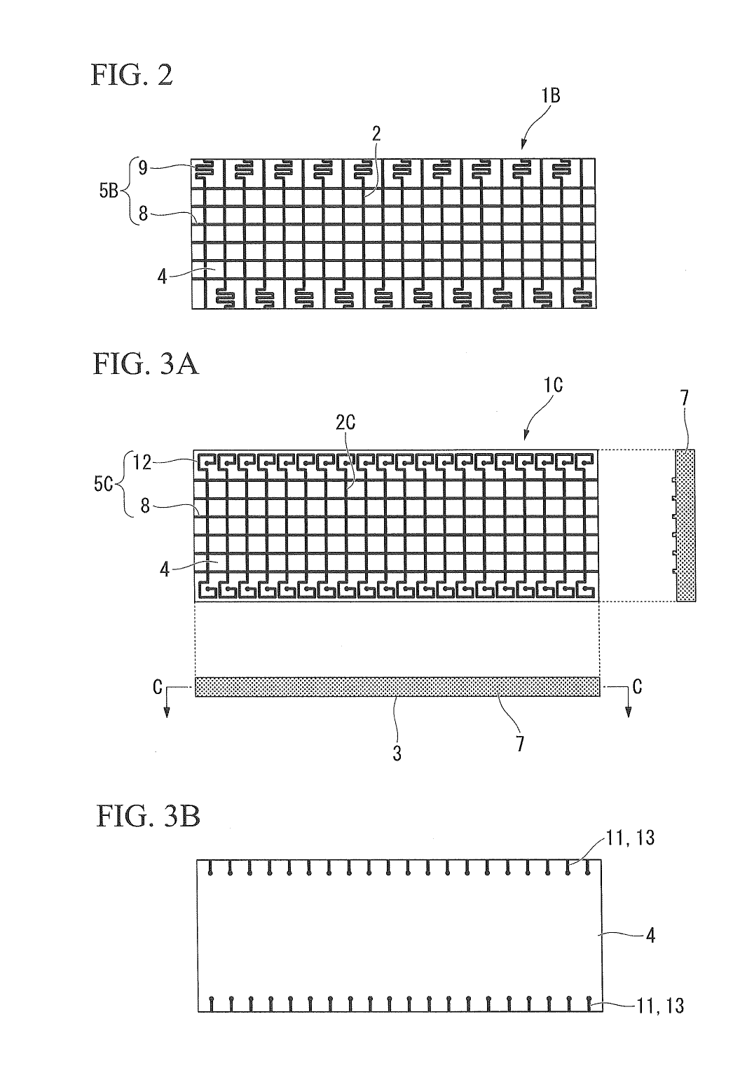

In the first embodiment, all distal ends of the mesh-shaped conductors 5 in the vicinity of the sheet have a meander shape, and a disposition interval of the meander-shaped conductor 9 is equal to a disposition interval of the linear conductor 8 that constitutes the mesh-shaped conductor 5. However, the disposition interval of the meander-shaped conductor 9 is not limited thereto but, as shown in FIG. 2, the meander-shaped conductor 9 may be the electromagnetic wave propagation sheet 1B disposed at twice (an integral multiple of) the disposition interval of the linear conductor 8, and the interval is not limited.

In this way, since inductance of a ferromagnetic field domain near the sheet end section is increased as the vicinity of the sheet end section of the mesh-shaped conductor 5 that forms the surface conductor layer 2 has a meander shape, a wavelength of an electromagnetic wave of a sheet transmission path can be reduced. According to the above-mentioned action, in the rail-shaped electromagnetic wave propagation sheet 1 elongated in one direction, a sheet width can be reduced to be smaller than a specific dimension determined by a frequency of the electromagnetic wave to be propagated in the sheet.

### Second Embodiment

FIGS. 3A and 3B are views showing an electromagnetic wave propagation sheet 1C according to a second embodiment for performing the present invention. The electromagnetic wave propagation sheet 1C of the second embodiment is distinguished from the electromagnetic wave propagation sheet 1 of the first embodiment in that an intermediate conductor layer 11 is disposed between a surface conductor layer 2C and the rear surface conductor layer 3. In addition, while a mesh-shaped conductor 5C of the surface conductor layer 2C has a shape in which the linear conductors 8 are arranged in a lattice shape, a spiral-shaped conductor 12 having a spiral shape is provided in the vicinity of the sheet end section.

A distal end of the spiral-shaped conductor 12 is connected to a conductor pattern 13 of the intermediate conductor layer 11 through a conductor such as a via or the like, and further, the conductor pattern 13 of the intermediate conductor layer 11 is connected to the short conductor 7 of the sheet end section. In FIG. 3A, while all distal ends of the mesh-shaped conductor 5C near the sheet have a spiral shape and the disposition interval of the spiral-shaped conductors 12 is equal to the disposition interval of the linear conductors 8 of the mesh-shaped conductor 5C, the disposition interval may be twice the disposition interval of the linear conductors 8, but is not limited thereto.

In this way, since inductance of the ferromagnetic field domain near the sheet end section is increased as the vicinity of the sheet end section of the mesh-shaped conductor that forms the surface conductor layer 2C has a spiral shape, a wavelength of the electromagnetic wave of the sheet transmission path can be reduced. Accordingly, in the rail-shaped electromagnetic wave propagation sheet 1C elongated in one direction, a sheet width can be reduced to be smaller than a specific dimension determined by a frequency of the electromagnetic wave to be propagated in the sheet.

### Third Embodiment

In a third embodiment, unlike the first embodiment in which the vicinity of the sheet end section of the mesh-shaped conductor has the meander shape, a conductor has a line width smaller than that of the linear conductor of the mesh-shaped conductor. That is, the linear conductor of the mesh-shaped conductor is reduced in a line width in the vicinity of the sheet end section.

Here, the thin line conductor requires that a length from the short conductor is smaller than λ/4. Provided that a characteristic impedance of a thin line conduction portion is set to Z₀, a length of a thin line is set to 1, and a wavelength in a line is set to λ, an input impedance Zin of the thin line when a short end side is seen from the mesh conductor side is expressed as the following equation (1), and the thin line acts as an inductance within a range of mλ/2<1<(mλ/2+λ/4), where m is an integer.

$$Zin = j {Z}_{0} tan \frac{2 π l}{λ} \qquad ( 1 )$$

As the thin line conductor is set as described above, inductance of the ferromagnetic field domain near the short end can be increased to reduce the wavelength, and the sheet width can be reduced.

### Fourth Embodiment

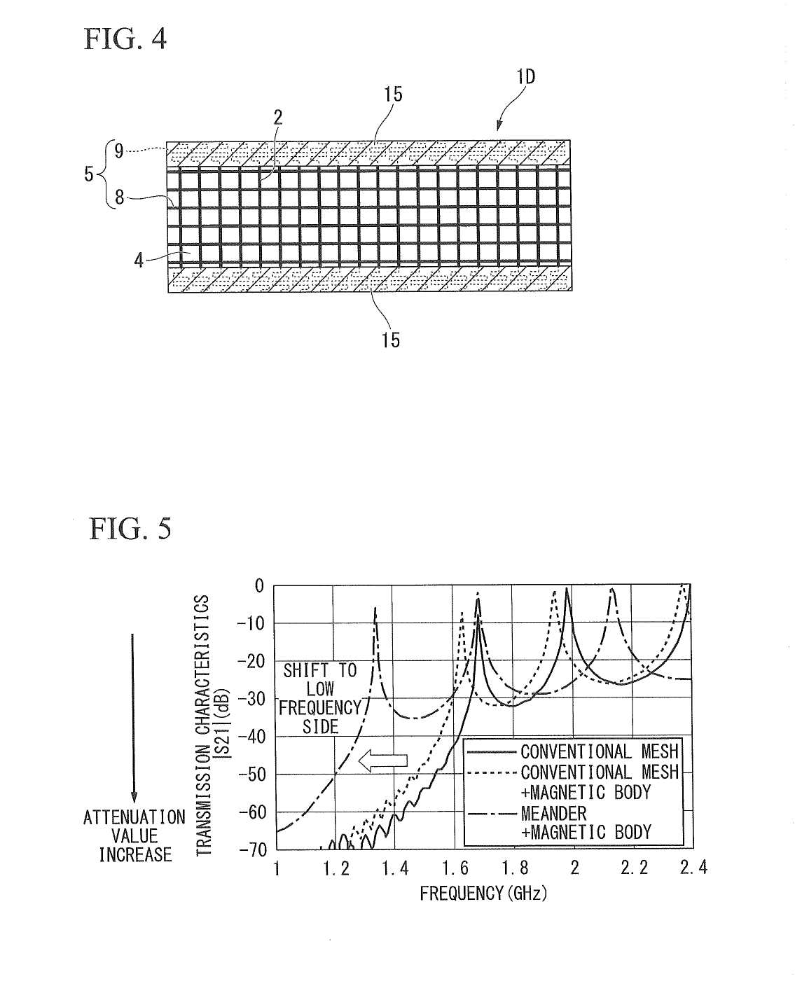

FIG. 4 is a view showing a fourth embodiment for performing the present invention. An electromagnetic wave propagation sheet 1D according to the fourth embodiment is characterized in that a magnetic body 15 is applied in the vicinity of a sheet end section. That is, the magnetic body 15 is applied on the meander-shaped conductor 9 described in the first embodiment, on the spiral-shaped conductor 12 described in the second embodiment, on the thin line conductor described in the third embodiment, or in the vicinity of the sheet end section of the electromagnetic wave propagation sheet of the related art. The applied magnetic body may be, for example, ferrite or the like.

In this way, since the inductance of the ferromagnetic field domain near the short end is further increased as the magnetic body 15 is applied in the vicinity of the sheet end section, the wavelength of the electromagnetic wave of the sheet transmission path can be further increased. For reference, FIG. 5 shows a result in which a wavelength reduction effect is confirmed through simulation. Transmission characteristics have been investigated by forming power supply points in the vicinity of both end surfaces in a longitudinal direction of the electromagnetic wave propagation sheet 1D.

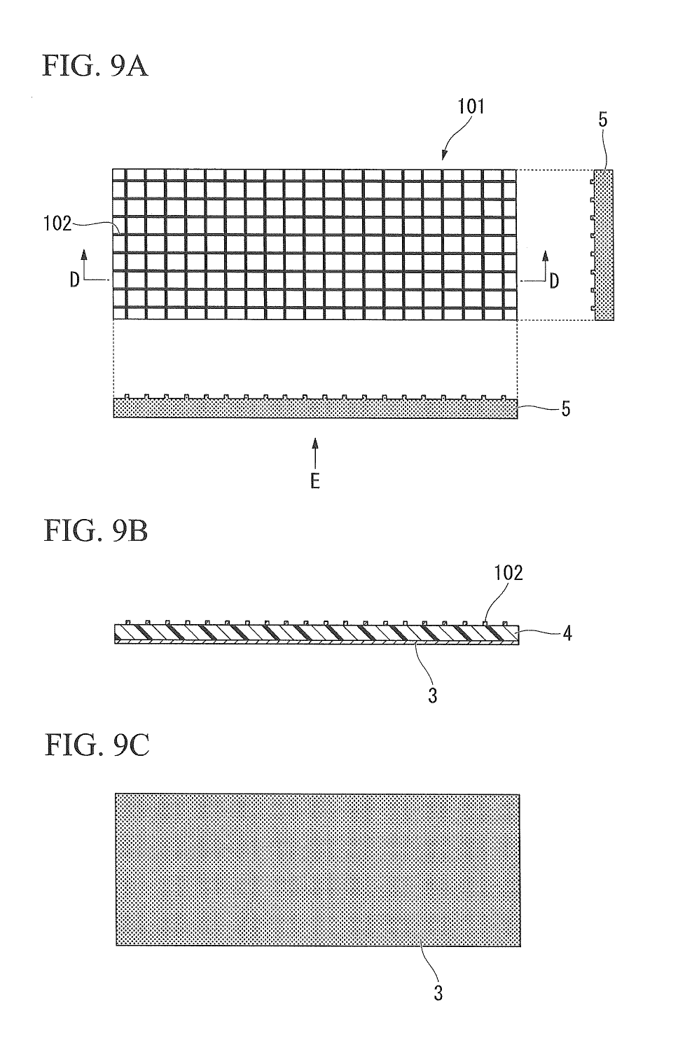

Transmission characteristics of three evaluation models of the sheet on which the magnetic body is applied in the vicinity of the sheet end section of the mesh-shaped conductor (“conventional mesh+magnetic body”), the sheet on which the magnetic body is not applied (FIG. 9, “conventional mesh”), and the sheet on which the magnetic body is applied in the vicinity of the sheet end section of the mesh-shaped conductor in a meander shape (FIG. 4, “meander+magnetic body”) have been verified.

As a result, it can be confirmed that, as the magnetic body is applied, a cutoff frequency (a frequency at which an attenuation value is increased and an electromagnetic wave is not propagated) is shifted to a lower frequency side. It will be appreciated that, as the magnetic body is applied, the wavelength of the electromagnetic wave that propagates in the sheet is largely reduced. In addition, it can be confirmed that, as the sheet end section has a meander shape, the wavelength is largely reduced.

According to the above-mentioned action, in the rail-shaped electromagnetic wave propagation sheet elongated in one direction, the sheet width can be reduced to be smaller than a specific dimension determined by a frequency of the electromagnetic wave to be propagated in the sheet.

### Fifth Embodiment

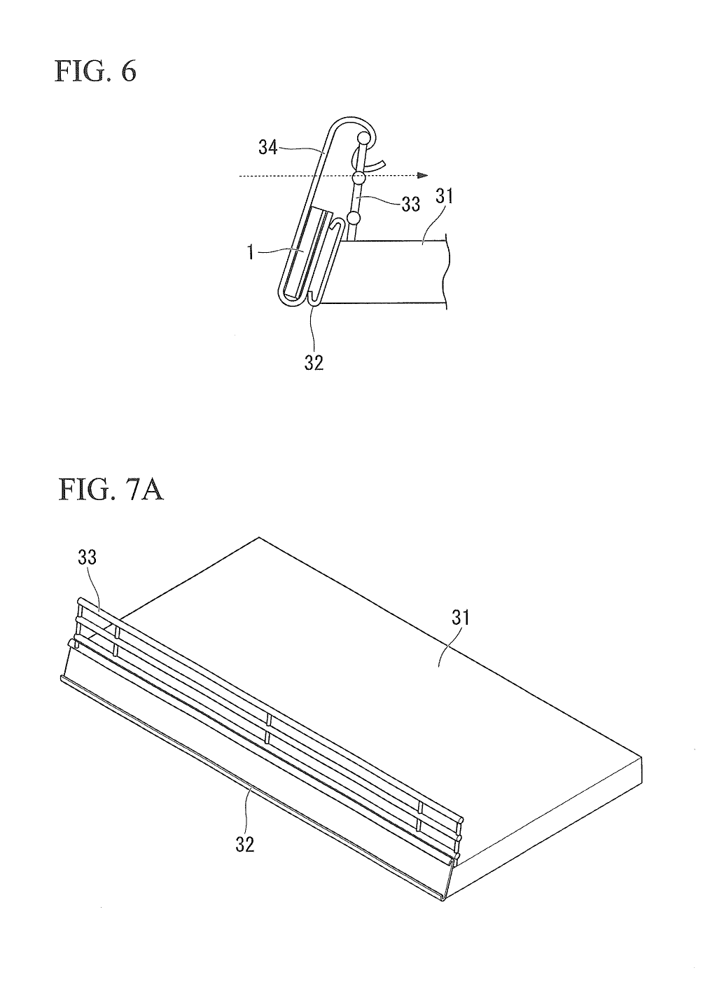

FIG. 6 is a view showing a fifth embodiment for performing the present invention. FIG. 5 shows an application example of the electromagnetic wave propagation sheet described in the first to fourth embodiments.

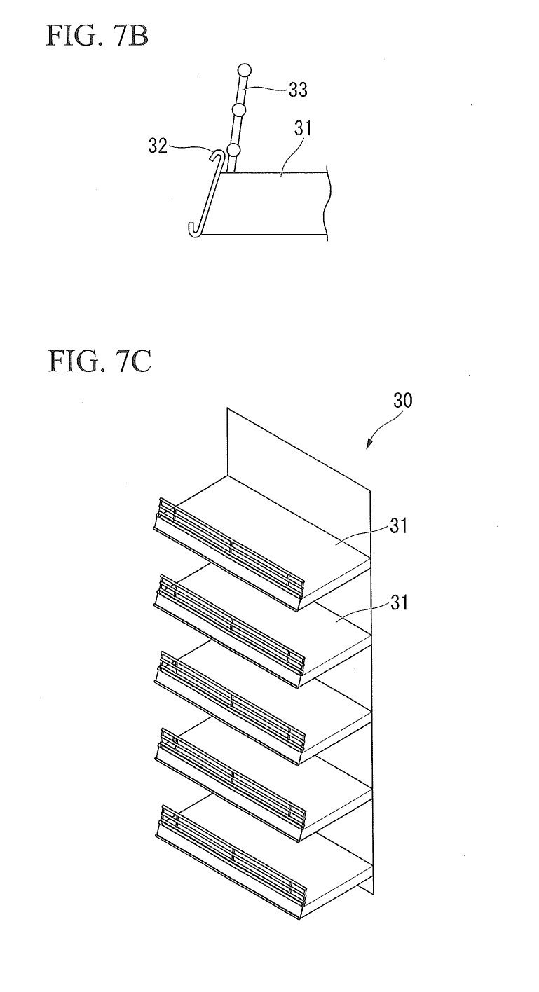

In a store such as a supermarket, a convenience store, or the like, goods are displayed using a display shelf 30 as shown in FIG. 7C. A plurality of shelf plates 31 as shown in FIGS. 7A and 7B are installed at the display shelf 30, and a price rail 32 on which a price tag is installed is attached to a front surface of each of the shelf plates 31. In addition, a shelf 33 constituted by a metal wire, which is called a handrail, can be attached to prevent goods from dropping from the display shelf 30.

As shown in FIG. 6, as the electromagnetic wave propagation sheet 1 is implemented on the shelf plate 31, supply of power to an electronic instrument on which a proximity coupler is mounted or communication between electronic instruments can be realized.

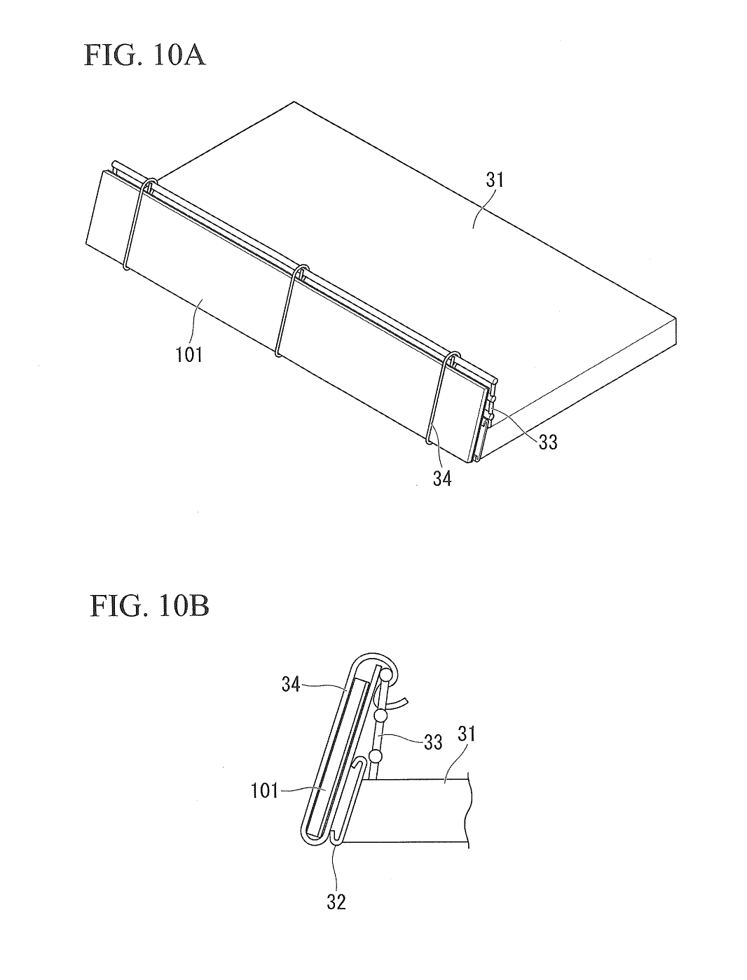

FIGS. 10A and 10B are views showing an example in which an electromagnetic wave propagation sheet 101 of the related art is applied to a shelf plate 31 of a display shelf As shown in FIGS. 10A and 10B, the electromagnetic wave propagation sheet 101 is implemented on the shelf plate 31, and supply of power to an electronic instrument on which a proximity coupler is mounted or communication between electronic instruments can be realized. When the electromagnetic wave propagation sheet 101 is implemented on the shelf plate 31, a dielectric layer may be formed on the outermost layer to protect upper and lower conductor layers of the sheet. As shown in FIGS. 10A and 10B, the electromagnetic wave propagation sheet 101 is held by the sheet holder 34 formed of plastic or the like, and a sheet holder 34 is hooked to the shelf 33 to be implemented on a front surface of the shelf plate 31. The electromagnetic wave propagation sheet 101 has a width to cover a height of the shelf 33 as well as a height of the shelf plate 31.

In addition, as shown in FIG. 6, an implementation height of the sheet can be suppressed to a low level using the electromagnetic wave propagation sheet 1 of the present invention (the sheet width can be reduced). That is, for example, while the electromagnetic wave propagation sheet 101 covers up to the height of the shelf 33 as shown in FIG. 10, as the electromagnetic wave propagation sheet 1 of the present invention is used, the height of the electromagnetic wave propagation sheet 1 can be suppressed to, for example, the height of the price rail 32.

A standard height of the shelf 33 and a standard height of the price rail 32 are about 30 mm. Showing an example of a result by simulation, in the case in which supply of power or communication is performed using an electromagnetic wave of a band of 2.4 GHz in the electromagnetic wave propagation sheet of a certain configuration (a specific material constant or dimension), when the electromagnetic wave propagation sheet 101 of the related art as shown in FIGS. 10A and 10B is used, a width of the electromagnetic wave propagation sheet 101 (a height of the sheet to cover the display shelf 30) is a width of, for example, 60 mm.

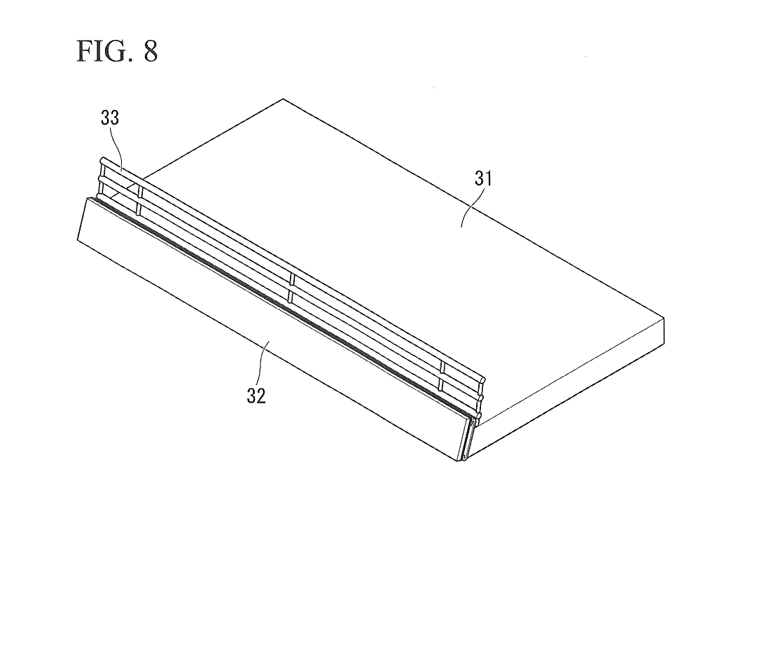

On the other hand, as the electromagnetic wave propagation sheet 1 of the present invention is applied, the sheet width can be suppressed and reduced (the sheet height can be reduced) to about 30 mm. Relative permeability of the magnetic body in the calculation was about 50. In this way, as the present invention is applied, goods displayed on the shelf plate 31 can he easily found and it can arouse customer interests. In addition, in FIG. 6, while the electromagnetic wave propagation sheet 1 is implemented on the shelf plate 31 by the sheet holder 34, as shown in FIG. 8, the electromagnetic wave propagation sheet 1 may be directly adhered to the front surface of the shelf plate 31 via an adhesive agent or the like.

Priority is claimed on Japanese Patent Application No. 2011-159565, filed Jul. 21, 2011, the content of which is incorporated herein by reference.

### INDUSTRIAL APPLICABILITY

The electromagnetic wave propagation sheet according to the present invention can provide the electromagnetic wave propagation sheet having a reduced implementation space obtained by reducing a sheet width.

### DESCRIPTION OF REFERENCE SYMBOLS

1 electromagnetic wave propagation sheet

2 surface conductor layer (mesh-shaped conductor layer)

3 rear surface conductor layer (planar conductor layer)

4 dielectric layer

7 short conductor

15 magnetic body

30 display shelf

31 shelf plate

1. An electromagnetic wave propagation sheet comprising:
a mesh-shaped conductor layer;
a planar conductor layer; and
an inductor layer sandwiched therebetween,
wherein the mesh-shaped conductor layer and the planar conductor layer are electrically connected to each other in an end section of the electromagnetic wave propagation sheet by a short conductor, and a mesh-shaped conductor that constitutes the mesh-shaped conductor layer has a meander shape in the vicinity of the electromagnetic wave propagation sheet end section.

2. An electromagnetic wave propagation sheet comprising:
a mesh-shaped conductor layer;
a planar conductor layer; and
a dielectric layer sandwiched therebetween,
wherein the mesh-shaped conductor layer and the planar conductor layer are electrically connected to each other in an end section of the electromagnetic wave propagation sheet by a short conductor, and a mesh-shaped conductor that constitutes the mesh-shaped conductor layer has a spiral shape in the vicinity of the electromagnetic wave propagation sheet end section.

3. An electromagnetic wave propagation sheet comprising:
a mesh-shaped conductor layer;
a planar conductor layer; and
a dielectric layer sandwiched therebetween,
wherein the mesh-shaped conductor layer and the planar conductor layer are electrically connected to each other in an end section of the electromagnetic wave propagation sheet by a short conductor, and a mesh-shaped conductor that constitutes the mesh-shaped conductor layer has a smaller line width in the vicinity of the electromagnetic wave propagation sheet end section than that of the other portion.

4. The electromagnetic wave propagation sheet according to claim 3, wherein a length of a thin line in the vicinity of the sheet end section of the mesh-shaped conductor is smaller than ¼ of a length of the electromagnetic wave propagated in the sheet.

5. The electromagnetic wave propagation sheet according to claim 1, wherein a magnetic body is applied in the vicinity of the electromagnetic wave propagation sheet end section.

6. An electromagnetic wave propagation sheet comprising:
a mesh-shaped conductor layer;
a planar conductor layer; and
a dielectric layer sandwiched therebetween,
wherein the mesh-shaped conductor layer and the planar conductor layer are electrically connected to each other in an end section of the electromagnetic wave propagation sheet by a short conductor, and a magnetic body is applied only in the vicinity of the electromagnetic wave propagation sheet end section.

7. A display shelf of a store having at least one shelf plate, wherein the electromagnetic wave propagation sheet according to claim 1 is implemented on a front surface of the shelf plate to be electrically connected by a short conductor in an end section, and a mesh-shaped conductor that constitutes a mesh-shaped conductor layer has a meander in the vicinity of the electromagnetic wave propagation sheet end section.
